(19) United States
(12) Patent Application Publication
(10) Pub. No.: US 2017/0141529 A1
(43) Pub. Date: May 18, 2017

(54) LASER MODULE

(71) Applicant: OPTONICS CO., LTD., Gwangju (KR)

(72) Inventors: Jong Sup KIM, Gwangsan-gu, Gwangju (KR); Young Woo LEE, Gwangsan-gu, Gwangju (KR)

(73) Assignee: Optonics Co., Ltd., Gwangju (KR)

(21) Appl. No.: 14/429,700

(22) PCT Filed: Dec. 8, 2014
(86) PCT No.: PCT/KR2014/011991

§ 371 Date: Mar. 19, 2015

(30) Foreign Application Priority Data
Jul. 9, 2014 (KR) 10-2014-0086334

(51) Int. Cl. H01S 3/101; H01S 3/16; H01S 3/091

(52) U.S. Cl. CPC H01S 3/101; H01S 3/091; H01S 3/1611; H01S 3/1643

(57) ABSTRACT

Disclosed herein is a laser module in which an optical block generating or controlling laser beams has a contact side surface made to have squareness, and neighboring optical blocks are coupled to each other in such a way that contact side surfaces thereof come into contact with each other, thus allowing the optical blocks to be aligned with each other and thereby obviating the necessity of additional alignment.

### TECHNICAL FIELD

The present invention generally relates to laser modules. More particularly, the present invention relates to a laser module in which an optical block generating or controlling laser beams has a contact side surface made to have squareness, and neighboring optical blocks are coupled to each other in such a way that contact side surfaces thereof come into contact with each other, thus allowing the optical blocks to be aligned with each other and thereby obviating the necessity of additional alignment.

### BACKGROUND ART

Generally, optical components for controlling and transmitting laser oscillation beams are optically aligned to cause laser beams to be efficiently generated, controlled, or transmitted. Such optical alignment is performed while or after each optical component is mounted on a mount for supporting the component.

A common solid state laser module for laser oscillation includes a laser beam source as an optical component mounted on an upper surface of a base that is principally made of a metal material, a laser resonator composed of a mirror mounted on either side of the laser beam source, and other components arranged to be continuous with the laser resonator. As mentioned above, the common laser resonator is configured such that the laser beam source, the mirror and the like are mounted on the upper surface of the base to be spaced apart from each other. As such, the optical components (i.e., the laser beam source, the mirror, etc.) should be mounted to be spaced apart from each other while being aligned with each other in order to increase efficiency to the maximum.

The optical components aligned on the base as such are usually coupled to the base by using a mechanical structure embedded in the base or the mount or by using an adhesive. The coupling using the mechanical structure or the adhesive is a method of mechanically fixing or adhering the optical components to the base in an optimally aligned state after they are optically aligned to each other. Korean Patent Laid-Open Publication No. 10-2010-0043709, which is entitled “small-sized solid laser excited with high-output laser diode”, discloses a technology of performing optical alignment by adhesion.

Incidentally, the optical alignment using the above-mentioned mechanical fixing or adhering method is problematic in that it is difficult to permanently maintain the alignment state, that is, the alignment state may be distorted by external shocks or vibrations or may be changed due to a change in temperature or humidity.

Moreover, the common laser module configured such that the optical components are mounted to be spaced apart from each other requires precise alignment between the components. The reason why the precise alignment is required has been already described above.

In order to solve the difficulty of the optical alignment, Korean Patent Laid-Open Publication No. 10-1994-0017015, which is entitled “laser diode/optical fiber aligning device and laser-diode-module aligning method”, discloses a technology of aligning optical components using an alignment-device body having a semi-circular groove formed about a concentric axis on an upper surface. The technology disclosed in the Laid-Open Publication is advantageous in that it is easy to align the optical components with each other by using the alignment-device body. However, this is problematic in that separate alignment-device bodies should be manufactured in view of the shape of the respective optical components, and optical alignment should be still separately performed between the optical components mounted on different alignment-device bodies.

### DISCLOSURE

### Technical Problem

Accordingly, the present invention has been made keeping in mind the above problems occurring in the related art, and is intended to provide a laser module in which an optical block generating or controlling laser beams has a contact side surface made to have squareness, and neighboring optical blocks are coupled to each other in such a way that contact side surfaces thereof come into contact with each other, thus allowing the optical blocks to be aligned with each other and thereby obviating the necessity of additional alignment.

### Technical Solution

In an aspect, the present invention provides a laser module having a plurality of optical blocks that are optically aligned and fixed, wherein all or some of the optical blocks are provided with contact side surfaces, neighboring optical blocks are optically aligned with each other by causing the contact side surfaces thereof to come into contact with each other, and the neighboring optical blocks are coupled with each other in a state where they come into contact with each other to be optically aligned.

Further, in the laser module of the present invention, the neighboring optical blocks coupled with each other by causing the contact side surfaces thereof to come into contact with each other may be coupled with each other by an optical contact coupling method.

Furthermore, in the laser module of the present invention, the laser module may include a laser-resonator-block assembly having a laser source block and mirror blocks coupled to both sides thereof.

Further, in the laser module of the present invention, the laser source block may include a block body having on both sides thereof contact side surfaces, and a pumping head configured such that both ends of a laser medium through which laser beams enter or exit are located at positions corresponding to the contact side surfaces of the block body, respectively, and are fixed to the block body.

Furthermore, in the laser module of the present invention, the block body of the laser source block may include a bottom portion and side-wall portions having on outer side surfaces thereof the contact side surfaces that are erected on both sides of the bottom portion, respectively, and the pumping head of the laser source block may be fixed to the block body of the laser source block in such a way that the both ends of the laser medium are supported on tops of respective side-wall portions of the block body of the laser source block.

Further, in the laser module of the present invention, seating depressions may be formed at central portions in a width direction on the tops of the respective side-wall portions of the block body of the laser source block so that the both ends of the laser medium of the pumping head of the laser source block may be seated therein, the both ends of the laser medium of the pumping head of the laser source block may be seated in the seating depressions, respectively and then they may be coupled to the tops of the side-wall portions of the block body of the laser source block via a fixing means.

Further, in the laser module of the present invention, each of the mirror blocks may include a block body having on both sides thereof contact side surfaces and an optical passage passing through the contact side surfaces; and a mirror attached to a predetermined contact side surface of the block body.

Further, in the laser module of the present invention, the optical passage of the block body of the mirror block may be made by forming holes through the contact side surfaces on the both sides of the block body.

Furthermore, in the laser module of the present invention, the laser module may include an optical block, the optical block including a block body having on both sides thereof contact side surfaces, and an optical component fixed to the block body in such a way that portions through which laser beams enter or exit are located at positions corresponding to the contact side surfaces of the block body.

Further, in the laser module of the present invention, the block body may include a bottom portion, and side-wall portions having on outer side surfaces thereof contact side surfaces that are erected on both sides of the bottom portion, respectively, and the optical component may be seated on the bottom portion between the side-wall portions and is thus fixed to the block body.

Furthermore, in the laser module of the present invention, the optical component may include a laser medium that protrudes at an end thereof to one side or both sides, the block body may include a seating depression that is formed at a central portion in a width direction on the top of the side-wall portion thereof so that the end of the laser medium of the optical component is seated therein, the end of the laser medium of the optical component may be seated in the seating depression and then be fixed to the top of the side-wall portion of the block body by fixing means.

Further, in the laser module of the present invention, the laser module may include a block body having contact side surfaces that face each other and an optical passage formed to pass through the contact side surfaces; and a mirror block having a mirror that is partially or wholly attached to the contact side surfaces of the block body.

Furthermore, in the laser module of the present invention, the optical passage of the block body of the mirror block may be made by forming holes through the contact side surfaces on the both sides of the block body.

### Advantageous Effects

As described above, the laser module according to the present invention is advantageous in that the optical block generating or controlling the laser beams has the contact side surface made to have the squareness, and neighboring optical blocks are coupled to each other in such a way that the contact side surfaces thereof come into contact with each other, thus allowing the optical blocks to be aligned with each other and thereby obviating the necessity of additional alignment.

### DESCRIPTION OF DRAWINGS

FIG. 1 is an exploded perspective view showing a laser-resonator-block assembly of a laser module according to an embodiment of the present invention;

FIG. 2 is a side view showing the laser-resonator-block assembly of the laser module according to the embodiment of the present invention;

FIG. 3 is an exploded perspective view showing a laser source block constituting the laser-resonator-block assembly of the laser module according to the embodiment of the present invention; and

FIG. 4 is a plan view showing a laser module according to an embodiment of the present invention including the laser-resonator-block assembly shown in FIGS. 1 to 3.

### DESCRIPTION OF REFERENCE NUMERALS OF IMPORTANT PARTS

10 laser amplifier block

20 direction diversion mirror block

30 laser-resonator-block assembly

31 laser source block

311 block body

311a bottom portion

311b, 311c side-wall portion

311b′, 311c′ contact side surface

311d, 311e seating depression

312 pumping head

312a, 312b laser medium end

32,3 3 mirror block

321, 331 block body

321a, 321b, 331a, 331b contact side surface

321c, 331c optical passage

322, 332 mirror

34 fixing means

341 coupler

342 bolt

### Mode for Invention

Hereinafter, a laser module according to an embodiment of the present invention will be described in detail with reference to the accompanying drawings.

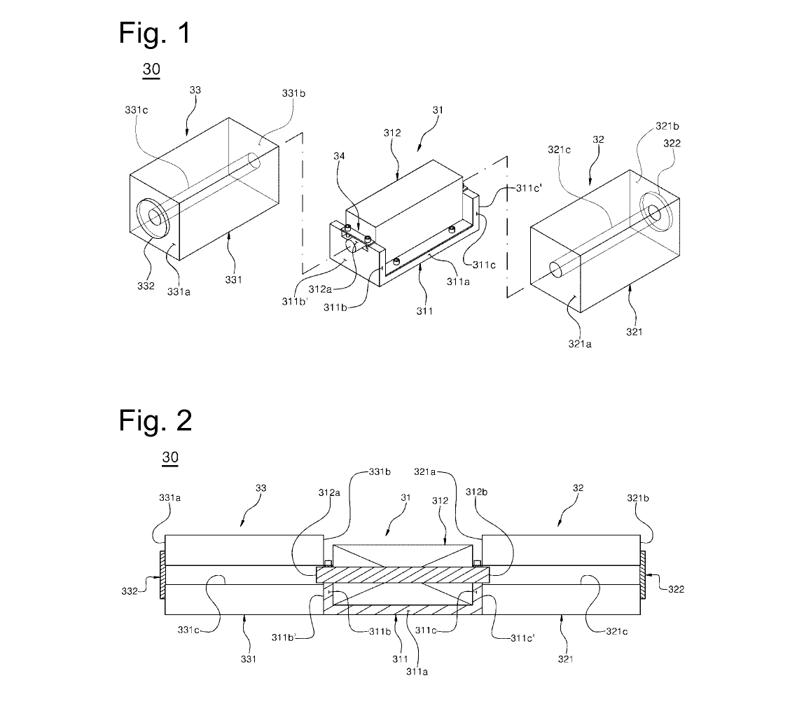

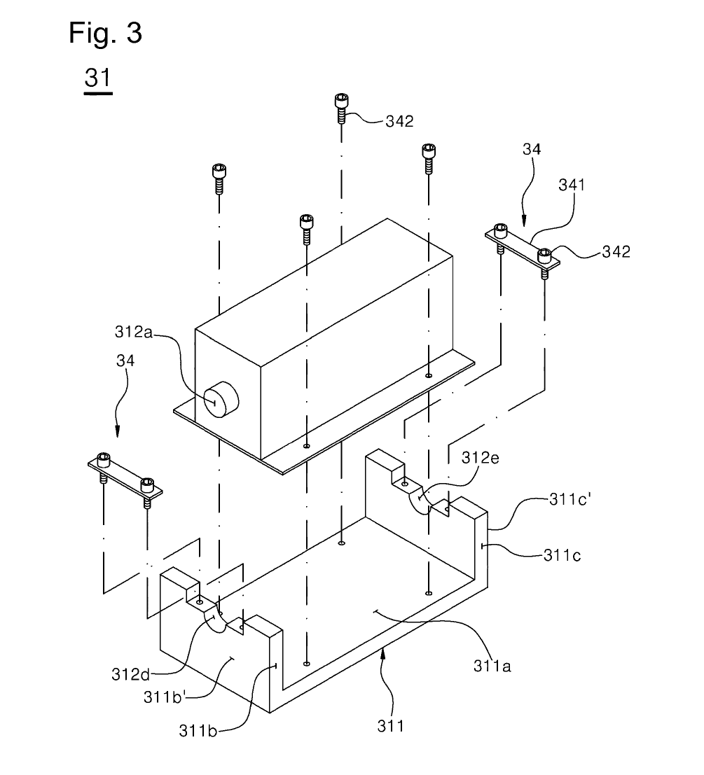

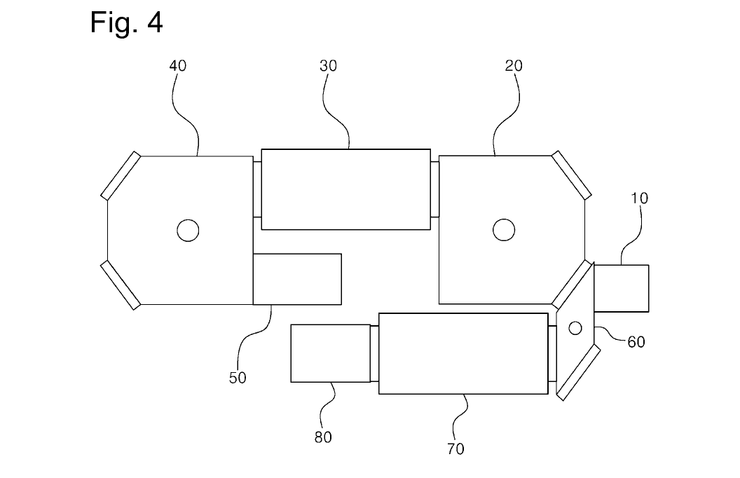

FIG. 1 is an exploded perspective view showing a laser-resonator-block assembly of a laser module according to an embodiment of the present invention, FIG. 2 is a side view showing the laser-resonator-block assembly of the laser module according to the embodiment of the present invention, FIG. 3 is an exploded perspective view showing a laser source block constituting the laser-resonator-block assembly of the laser module according to the embodiment of the present invention, and FIG. 4 is a plan view showing a laser module according to an embodiment of the present invention including the laser-resonator-block assembly shown in FIGS. 1 to 3.

The laser module according to the embodiment of the present invention is configured such that a contact side surface is provided on each of the optical blocks, and optical alignment is performed between neighboring optical blocks by coupling contact side surfaces of the neighboring optical blocks to each other.

FIG. 4 illustrates the laser module according to the embodiment of the present invention, in which various optical blocks are connected to each other to realize the optical alignment, while FIGS. 1 to 3 illustrate the laser-resonator-block assembly constituting the laser module shown in FIG. 4. For the convenience of description, the main features of the present invention will be described starting from the laser-resonator-block assembly 30 of FIGS. 1 to 3, in which three optical blocks are coupled to each other.

Referring to FIGS. 1 to 3, the laser-resonator-block assembly 30 includes one laser source block 31 located at a center thereof and two mirror blocks 32 and 33 located on both sides of the laser source block 31, and is a laser resonator module for resonating laser beams that are generated therein or are incident from an outside. That is, as shown in FIGS. 1 to 3, the laser-resonator-block assembly 30 itself may comprise one laser module. Referring to FIGS. 1 to 3, the laser-resonator-block assembly 30 is an assembly having three optical blocks 31, 32, and 33 that are coupled to each other (i.e., the laser-resonator-block assembly 30 itself is the laser resonator module), and is configured such that three neighboring optical blocks come into contact with each other to realize the optical alignment, as described above as the main features of the present invention.

The laser source block 31, which is one of the three optical blocks constituting the laser-resonator-block assembly 30, includes a block body 311 and a pumping head 312 accommodated in the block body 311. The block body 311 is configured to have on both sides thereof contact side surfaces 311b′ and 311c′ of the laser source block 31, with the pumping head 312 coupled to an inside thereof. The pumping head 312 includes a laser medium, a pumping light source, coolant, etc.

In the drawings, the block body 311 of the laser source block 31 is provided with a bottom portion 311a, and side-wall portions 311b and 311c having on outer side surfaces thereof the contact side surfaces 311b′ and 311c′ that are erected up on both sides of the bottom portion 311a, thus having an approximately ‘U’-shape. This is a structure that is suitable for receiving a body of the pumping head 312 between the side-wall portions 311b and 311c and for supporting both ends 312a and 312b of the laser medium protruding in opposite directions from the body of the pumping head 312 on the side-wall portions 311b and 311c.

Meanwhile, the structure of the ‘U’-shaped block body is not restrictively applied to only the laser source block 31. That is, in the laser module according to the embodiment of the present invention, the optical component (e.g., a pumping head, a seed laser, a laser amplifier, etc.) having an end into or from which laser beams enter or exit may adopt the structure of the ‘U’-shaped block body.

Meanwhile, semi-circular seating depressions 311d and 311e are formed at central locations in a width direction on top of the respective side-wall portions 311b and 311c of the block body 311 of the laser source block 31 so that the both ends of the laser medium of the pumping head of the laser source block are seated therein. The both ends 312a and 312b of the laser medium of the pumping head 312 of the laser source block 31 are seated in the seating depressions 311d and 311e, respectively. In this state, they are coupled to the tops of the side-wall portions 311b and 311c of the block body 311 of the laser source block 31 via a fixing means 313. The fixing means 313 functions to fix the both ends 312a and 312b of the laser medium of the pumping head 312 and thereby prevent them from being removed from the seating depressions 311d and 311e. The fixing means 313 includes a coupler 313a that is placed to cross the both ends 312a and 312b of the laser medium of the pumping head 312 to press the both ends 312a and 312b of the laser medium of the pumping head 312 downwards, and bolts 313b that fasten both ends of the coupler 313a to tops of the side-wall portions 311b and 311c of the block body 311.

The pumping head 312 of the laser source block 31 is provided with the laser medium for amplifying the laser beams, the laser beams entering or exiting through the both ends of the laser medium. As the laser medium, an Nd:YAG is principally applied. The both ends 312a and 312b of the laser medium of the pumping head 312 are seated in the seating depressions 311d and 311e to be placed on the insides or outsides of the faces, or just on the faces of the contact side surfaces 311b′ and 311c′ of the block body 311. Be placed, after then fastened the body is fastened to the bottom portion 331a of the block body 311 via bolts 342.

The laser source block 31 configured as such has on both sides of the block body 311 the contact side surfaces 311b′ and 311c′. The contact side surfaces 311b′ and 311c′ come into contact with the contact side surfaces 321a and 331a of the neighboring mirror blocks 32 and 33, so that the laser source block 31 and the mirror blocks 32 and 33, which are adjacent to each other, are coupled with each other while being optically aligned with each other.

The mirror blocks 32 and 33 are coupled to both sides of the laser source block 31, respectively, and are provided with mirrors 322 and 332 for reflecting all or some of the laser beams that are emitted from the laser medium of the laser source block 31. Referring to the drawings, the mirror blocks 32 and 33 are formed in the shape of a block that is configured such that contact side surfaces 321a, 321b, 331a, 331b are provided on both sides thereof to be parallel to each other while facing each other. Optical passages 321c and 331c permitting the passage of the laser beams may be formed in the mirror blocks 32 and 33 in such a way as to penetrate through the contact side surfaces 321a, 321b, 331a, 331b. The drawing illustrates an example where the optical passages 321c and 331c are defined by holes passing through the contact side surfaces 321a, 321b, 331a, 331b located on both sides of the block assisting bodies 321 and 331 of the mirror blocks 32 and 33. The mirror 322, 332 is attached to the contact side surface 321b, 331a on a side of the block body 321, 331 of the mirror block 32, 33. A surface of the mirror 322, 332 is very precisely machined to become a plane. The mirror is attached to the contact side surface 321b, 331a on a side of the block body 321, 331 by the above-mentioned optical contact coupling method.

The mirror blocks 32 and 33 coupled to both sides of the laser source block 31 have a symmetrical structure with respect to each other. However, in order to cause some of the resonated laser beams to exit, one of the mirrors 322 and 332 corresponds to a mirror having partial transmitting ability. In FIG. 4, another optical block 20 is connected to the mirror block 33 placed on the left of the laser source block 31 among the mirror blocks 32 and 33. In this case, the mirror 332 attached to the mirror block 33 placed on the left of the laser source block 31 among the mirror blocks has the partial transmitting ability.

Meanwhile, in FIG. 4, the direction diversion mirror block 20 and the amplifier block 10 are successively coupled to the laser-resonator-block assembly 30 configured as such. The laser-resonator-block assembly 30 and the diversion mirror block 20 adjacent thereto are configured to implement contact coupling and optical alignment of the contact side surfaces that are the main feature of the present invention.

That is, the mirror block 33 adjacent to the direction diversion mirror block 20 is coupled as follows: a contact side surface 331b to which a mirror 332 is not attached is in contact with the contact side surface 311b′ of the laser source block 31, and a side to which the mirror 332 is attached is coupled while being in contact with the direction diversion mirror block 20 adjacent thereto. In the drawing, the mirror 332 is coupled to the contact side surface 331a of the block body 331 by the optical contact coupling method in such a way as to protrude from the contact side surface 331a. In this case, an outer surface of the mirror 332 is in contact with the contact side surface of the direction diversion mirror block 20 to function as a contact side surface, and the direction diversion mirror block 20 coupled thereto is coupled to the outer surface of the mirror 332 while being in contact therewith.

As described above, the mirror block 32, 33 of the laser-resonator-block assembly 30 is characterized in that it has a contact side surface and the contact side surface comes into contact with the contact side surface of another adjacent optical block, thus realizing the optical alignment. The structure of the block body 321, 331 wherein the contact side surface is provided and the optical passage passing through the contact side surface is formed in the form of a hole as in the mirror block 32, 33 may be applied to another mirror block. That is, in the case of the optical block to which a mirror or lens is coupled in the laser module according to the present invention shown in FIG. 4, it is possible to make the optical passage by forming the contact side surface at a required position and forming the hole through the contact side surface. For example, as for the direction diversion mirror block 20 of FIG. 4, it is preferable to adopt the block body, which is configured such that the contact side surfaces are formed at facing positions and the optical passage is penetrated between the contact side surfaces. On the other hand, the contact side surfaces of the block body may face each other in parallel or may face each other obliquely so as to enable a change in direction or course. For example, in the direction diversion mirror block 20, four contact side surfaces are formed at facing positions at an angle of 45°, 90° or the like. Mirrors may be partially attached to the contact side surfaces to reflect laser beams, and an optical passage (not shown) may be defined between the contact side surfaces.

As described above, the laser-resonator-block assembly itself shown in FIGS. 1 to 3 is an independent laser resonator module (i.e., the laser module) that achieves the optical alignment while three optical blocks are coupled with each other via the contact side surfaces. This may be coupled to different optical blocks 10 and 20, thus forming another laser module, as shown in FIG. 4.

FIG. 4 shows a laser module according to an embodiment of the present invention including the above-mentioned laser-resonator-block assembly 30. Referring to FIG. 4, the laser module includes the laser-resonator-block assembly 30 for resonating laser beams, the direction diversion mirror block 20 for changing the direction of emitted laser beams, and the laser amplifier 10 for amplifying laser beams.

As described above, the optical blocks 31, 32, 33, 20, and 10 are characterized in that the contact side surfaces provided on the sides thereof come into contact with each other to realize the optical alignment and neighboring optical blocks are coupled to each other in the state where the contact side surfaces are in contact with each other to realize the optical alignment.

Meanwhile, the present invention is characterized in that the coupling of neighboring optical blocks via the contact side surfaces is performed by the optical contact coupling method, so that the optical alignment using the adhesive such as epoxy or solder or mechanical means is not required. The optical contact coupling method uses a coupling force generated by the contact between precisely machined surfaces. The coupling force uses a short-distance intermolecular coupling force such as the Van der Waal's Force.

The present invention is characterized in that the blocks are coupled to each other and simultaneously the optical alignment is achieved by using the above-mentioned optical contact coupling method. For the optical contact coupling, the contact side surface of the optical block should be machined such that flatness is superior and roughness is very low. For example, the contact side surface of the optical block is preferably formed such that a peak to valley flatness has 1/50 to 1/4 of the wavelength (λ) of the laser beam and root mean square roughness (rms value) has 0.2×10⁻¹⁰ m (0.2 Å) to 2×10⁻¹⁰ m (2 Å). Further, for the optical contact coupling, the contact side surface of the optical block preferably undergoes a cleaning process so that foreign matter having the diameter of 5 μm or more is not present.

Furthermore, the optical block is preferably made of a material having a low thermal expansion coefficient. As this material, it is preferable to use either a Zerodur material or a ULE material, which has the low thermal expansion coefficient of approximately 0.01×10⁻⁶ K in a temperature range from −20° C. to 80° C.

Although the embodiments of the present invention have been disclosed for illustrative purposes, those skilled in the art will appreciate that various modifications, additions and substitutions are possible, without departing from the scope and spirit of the invention as disclosed in the accompanying claims.

### INDUSTRIAL APPLICABILITY

As described above, the present invention provides a laser module, in which neighboring optical blocks are coupled to each other in such a way that contact side surfaces thereof come into contact with each other, thus allowing the optical blocks to be aligned with each other and thereby obviating the necessity of additional alignment.

1. A laser module having a plurality of optical blocks that are optically aligned and fixed,
wherein all or some of the optical blocks are provided with contact side surfaces, neighboring optical blocks are optically aligned with each other by causing the contact side surfaces thereof to come into contact with each other, and the neighboring optical blocks are coupled with each other in a state where they come into contact with each other to be optically aligned.

2. The laser module according to claim 1, wherein the neighboring optical blocks coupled with each other by causing the contact side surfaces thereof to come into contact with each other are coupled with each other by an optical contact coupling method.

3. The laser module according to claim 1, wherein the laser module comprises a laser-resonator-block assembly having a laser source block and mirror blocks coupled to both sides thereof.

4. The laser module according to claim 3, wherein the laser source block comprises:
a block body having on both sides thereof contact side surfaces; and
a pumping head configured such that both ends of a laser medium through which laser beams enter or exit are located at positions corresponding to the contact side surfaces of the block body, respectively, and are fixed to the block body.

5. The laser module according to claim 4, wherein the block body of the laser source block comprises:
a bottom portion; and
side-wall portions having on outer side surfaces thereof the contact side surfaces that are erected on both sides of the bottom portion, respectively,
the pumping head of the laser source block is fixed to the block body of the laser source block in such a way that the both ends of the laser medium are supported on tops of respective side-wall portions of the block body of the laser source block.

6. The laser module according to claim 5, wherein seating depressions are formed at central portions in a width direction on the tops of the respective side-wall portions of the block body of the laser source block so that the both ends of the laser medium of the pumping head of the laser source block are seated therein,
the both ends of the laser medium of the pumping head of the laser source block are seated in the seating depressions, respectively and then they are coupled to the tops of the side-wall portions of the block body of the laser source block via fixing means.

7. The laser module according to claim 3, wherein each of the mirror blocks comprises:
a block body having on both sides thereof contact side surfaces, and an optical passage passing through the contact side surfaces; and
a mirror attached to a predetermined contact side surface of the block body.

8. The laser module according to claim 7, wherein the optical passage of the block body of the mirror block is made by forming holes through the contact side surfaces on the both sides of the block body.

9. The laser module according to claim 1, wherein the laser module comprises an optical block, the optical block comprising:
a block body having on both sides thereof contact side surfaces; and
an optical component fixed to the block body in such a way that portions through which laser beams enter or exit are located at positions corresponding to the contact side surfaces of the block body.

10. The laser module according to claim 9, wherein the block body comprises:
a bottom portion; and
side-wall portions having on outer side surfaces thereof contact side surfaces that are erected on both sides of the bottom portion, respectively, and
the optical component is seated on the bottom portion between the side-wall portions and is thus fixed to the block body.

11. The laser module according to claim 10, wherein the optical component comprises a laser medium that protrudes at an end thereof to one side or both sides,
the block body comprises a seating depression that is formed at a central portion in a width direction on the top of the side-wall portion thereof so that the end of the laser medium of the optical component is seated therein,
the end of the laser medium of the optical component is seated in the seating depression and then is fixed to the top of the side-wall portion of the block body by fixing means.

12. The laser module according to claim 1, wherein the laser module comprises:
a block body having contact side surfaces that face each other, and an optical passage formed to pass through the contact side surfaces; and
a mirror block having a mirror that is partially or wholly attached to the contact side surfaces of the block body.

13. The laser module according to claim 12, wherein the optical passage of the block body of the mirror block is made by forming holes through the contact side surfaces on the both sides of the block body.

14. The laser module according to claim 2, wherein the laser module comprises a laser-resonator-block assembly having a laser source block and mirror blocks coupled to both sides thereof.

15. The laser module according to claim 14, wherein the laser source block comprises:
a block body having on both sides thereof contact side surfaces; and
a pumping head configured such that both ends of a laser medium through which laser beams enter or exit are located at positions corresponding to the contact side surfaces of the block body, respectively, and are fixed to the block body.

16. The laser module according to claim 15, wherein the block body of the laser source block comprises:
a bottom portion; and
side-wall portions having on outer side surfaces thereof the contact side surfaces that are erected on both sides of the bottom portion, respectively,
the pumping head of the laser source block is fixed to the block body of the laser source block in such a way that the both ends of the laser medium are supported on tops of respective side-wall portions of the block body of the laser source block.

17. The laser module according to claim 16, wherein seating depressions are formed at central portions in a width direction on the tops of the respective side-wall portions of the block body of the laser source block so that the both ends of the laser medium of the pumping head of the laser source block are seated therein,
the both ends of the laser medium of the pumping head of the laser source block are seated in the seating depressions, respectively and then they are coupled to the tops of the side-wall portions of the block body of the laser source block via fixing means.

18. The laser module according to claim 14, wherein each of the mirror blocks comprises:
a block body having on both sides thereof contact side surfaces, and an optical passage passing through the contact side surfaces; and
a mirror attached to a predetermined contact side surface of the block body.
